(19) United States
(12) Patent Application Publication
(10) Pub. No.: US 2026/0231884 A1
(43) Pub. Date: Aug. 13, 2026

(54) SYSTEM AND METHODS FOR GROWING PLANTS AS AN AUTOMATED CAROUSEL USING RAS (RECIRCULATING AQUACULTURE SYSTEMS), AQUAPONICS AND SOIL AS A MEDIUM

(71) Applicant: Alexsandar Sakota, San Gwann (MT)

(72) Inventor: Alexsandar Sakota, San Gwann (MT)

(21) Appl. No.: 19/155,314

(22) PCT Filed: Aug. 28, 2023
(86) PCT No.: PCT/IB2023/058483

§ 371 Date: Aug. 11, 2025

(51) Int. Cl. A01G 31/04; A01G 7/04

(52) U.S. Cl. CPC A01G 31/047; A01G 7/045

(57) ABSTRACT

A system for growing a plurality of plants as an automated carousel using aquaponics and soil as a medium includes, a plurality of trays for growing said plurality of plants, each tray of said plurality of trays being arranged in a unique arrangement; a light source comprising a plurality of LEDs, said light source being configured to provide light energy to said plurality of trays for growing said plurality of plants; a water supply source and an electricity supply source for growing said plurality of plants; and, an aquaponics system for growing said plurality of plants, said aquaponics system being configured to use six times less water and fish for growing said plurality of plants.

### FIELD OF THE INVENTION

Embodiments of the present invention generally relate to the field of growing plants, and, more particularly, to systems and methods for growing plants as an automated carousel using RAS (Recirculating Aquaculture Systems), aquaponics and soil as a medium.

### BACKGROUND OF THE INVENTION

As it is well known that there are various methods of agriculture for the optimum utilization of resources like space, water, and nutrients. Aquaponics is one of the methods that has evolved over the period. The aquaponics method combines agriculture with hydroponics which allows plants to feed from nutrient-rich aquaculture water.

Aquaponics is a soilless agriculture method of growing crops using fresh water from fish tanks, which provides nutrients for plants. There are different soilless ways of growing plants in an aquaponics system. However, on a commercial scale is very difficult to maintain the eco-balance required for the fish and crops. Very few commercial aquaponics farms use floating beds (DWC, Deep water culture).

Further, the system also projects some technical challenges which require a multi-disciplinary approach from environmental, mechanical and civil concepts about water plant ecology, biochemistry and biotechnology. This results in increasing difficulty, affecting the running system's efficiency issues. Therefore, several experiments have been conducted over time in the aquaponics method of agriculture to solve the issue mentioned above, which include ph stabilization and nutrient balance.

In a recent development, vertical farms are harnessed in aquaponics agriculture for a sufficient water supply. Vertical farms distribute water to crops which causes plants closer to the entry point of water to grow better compared to plants on the far end, as well as access to lights is not the same for all plants, and this will affect the growth of plants.

The study has been conducted for an automated aquaponic system which can be operated to maintain and control various parameters of an aquaponics method by interconnecting various detectors and actuators with a microcontroller to improve productivity. The said automation is applied for testing purposes which are considered more efficient than the traditional testing method. However, the technological development in this area has not been implemented to make it sustainable and feasible in order to expand on a large scale.

The requirements of energy for aquaponics require system configuration and geographic location based on the different measures, are needed to ensure each system has sustainable power resources that supply steady conditions for fish and plants. In addition, further technology is required to adjust the temperature in seasonal change climate.

In accordance with the conventional prior art disclosure, there are different vertical aquaponics farms available on the market in the shape of letter A, single towers, rack/shelving systems, Deep Water Culture DWC, different types of Media beds or growing the plants in pipes/NFT. All these vertical farms reduce the space required for farming. However, these are in insertion with various other components and consume considerable electricity, wherein it is impractical to sustain the consistent growth of plants. Especially when LED lights are employed above all plants, it increases operating expenses quite a lot.

The biggest problem of innovative vertical farms is that cost per Kg of produce is very high and not profitable on its own. Therefore, one has to introduce new revenue channels apart from selling produce, such as: selling hardware and educational material and offering farm tours. These challenges need to be resolved to establish fully collected and regularised aquaponic systems that will be easy to control and economically viable.

Subsequently, there are various prior art disclosures wherein the aquaponics method is inefficient in solving all the problems that arise during the agriculture process, such as inconsistent water distribution among all plants and lack of eco-balance between fish and crops, along with high electricity consumption and high cost. Therefore, there need to be improved methods capable of automatically equipping the lengthy process involved in aquaponics which can also resolve the issues that arise during the cultivation.

With regard to the above-mentioned problem, there is a need for a new system that can overcome the issues related to conventional aquaponics systems. Overall, a method that could be automated and simultaneously reduce the amount of water and energy required for nurturing the plants is needed. Such a system and method can be designed in a way that consumes less water and electricity compared to standard aquaponics systems. In addition, an eco-balanced approach is required to provide enough nutrients for the growth of plants. Accordingly, there remains a need in the art for innovative, novel, efficient solutions for growing plants as an automated carousel using aquaponics and soil as a medium.

### SUMMARY OF THE INVENTION

The embodiments of the present disclosure have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description”, one will understand how the features of the present embodiments provide advantages.

In one embodiment, a system for growing a plurality of plants as an automated carousel using aquaponics and soil as a medium includes, a plurality of trays for growing said plurality of plants, each tray of said plurality of trays being arranged in a unique arrangement; a light source comprising a plurality of LEDs, said light source being configured to provide light energy to said plurality of trays for growing said plurality of plants; a water supply source and an electricity supply source for growing said plurality of plants; and, an aquaponics system for growing said plurality of plants, said aquaponics system being configured to use six times less water and fish for growing said plurality of plants.

### BRIEF DESCRIPTION OF THE DRAWINGS

FIG. 1 illustrates various views of a system for growing a plurality of plants as an automated carousel using aquaponics and soil as a medium, in accordance with embodiments of the present invention.

### DETAILED DESCRIPTION

Various embodiments of the present invention are aimed at providing novel and inventive solutions for growing plants as an automated carousel using aquaponics and soil as a medium. Generally, aquaponics is a soil-less method of growing crops using fresh water from fish tanks, which provides nutrients for plants. Aquaponics is an applied method of growing plants wherein nutrient film technique, media bed, and deep-water culture are employed to develop plants. In this process, raising fish provides a source of nutrients for nitrogen-consuming bacteria. Nutrient-rich water feeds the plant and keeps them healthy.

Particularly, the aquaponics system requires two components, plants and fish. The fish extract is converted to nitrates which are then supplied directly to the roots of the plants. Plants take up this nitrate as nutrients and clean up the water. This water is pumped back to the fish tanks, and the cycle continues. The aquaponics process requires copious amounts of water and fish and maintaining water nutrients and eco-balance for the fish and plants. The method requires three types of LED (grow lights) to develop plants. Only a handful of commercial aquaponics farms use floating beds (DWC, Deep water culture).

Generally, the cost per kilogram of produce is quite high and not profitable on its own, which is the main issue with novel vertical farms. Vertical farms must deliver water to crops, which will cause plants at the water entry point to grow better than plants on the far end. Additionally, not all plants have the same access to light, which will also have an impact on plant growth. Operational costs are greatly raised, especially if LED lights are used above all plants since they have a lot more components, which also increases the risk of mechanical failure and worsens inadequacies in plant growth. There remains a need for a sustainable method to increase efficiency in the growth of plants and cut the cost and effort of maintenance to expand its usage.

There are various embodiments of the present invention that are disclosed herein below that relate to automated carousel using aquaponics and soil as medium. The machine is automated, using six times less water, six times less fish, less space, and less energy needed to grow the plants. The technique has been shown to contribute to an all-year growth of vegetation with minimal water supply, electricity, and space, as well as the fact that there is no addition of fertilizer, pesticide, or any other cancer-causing chemicals. This solves the issue of producing products in specific seasons. The creative approach only employs fish follicle-infused water to provide extra nutrition to the plants and to help regenerate the soil, which is used as medium for growing plants.

In accordance with an embodiment of the present invention, the method of automated carousel using aquaponics and soil as medium comprises the steps of: placing tray balances the wheel based on the planted vegetation; depositing water at the base of the wheel depending on the season and the vegetables that are grown; fastening buckets/pots are to trays in order to provide enough space for that particular plant to grow; and rotating wheel rotates at a set time and according to a specified season and nurtured crops.

Additionally, in accordance with an embodiment of the present invention, the automated carousel using aquaponics and soil as medium comprises trays, buckets, stand, an electricity supply, a light source comprising LEDs, six times less fish compared to other methods, soil in the bucket, and a water supply source to water at the base. This aquaponic system is configured to use six times less fish and water as compared to other traditional methods, for growing plants. In use, the water with fish follicles provides nutrients for plant growth, as plants get nutrients from soil and fish water is used to provide even more nutrients for crops, enabling faster harvest time and healthier plants and soil all year round.

Furthermore, in accordance with an embodiment of the present invention, the automated carousel using aquaponics and soil as medium comprises an automated process of aquaponics. In use, the automated process makes it virtually hands-free; plants are grown in soil and further the system is automated from inserting seedlings into the machine till the time of harvesting.

Furthermore, in accordance with an embodiment of the present invention, the system is embodied in a shape of a Ferris wheel structure, to enable exposure of a maximum number of plants to a single set of LEDs (disclosed below).

Further, in operation, the wheel turns at a specific time according to the growth of the nurtured crop, according to the type of nurtured crop and also depending on the season. A specific amount of water is placed at the base of the wheel depending on the season and nurtured crop.

Additionally, in accordance with an embodiment of the present invention, the automated carousel using aquaponics and soil as medium further comprises trays for growing plants; each tray is arranged in a unique arrangement. In use, each tray is designed and attached to the Ferris wheel. In use, the tray balances the wheel according to the nurtured crop.

Furthermore, in accordance with an embodiment of the present invention, the system comprises a light source comprising LEDs. In use, the light source is configured to provide light energy to the trays for growing plants.

Moreover, in accordance with an embodiment of the present invention, the automated carousel using aquaponics and soil as medium, this system further comprises buckets. In use, buckets are fixed on trays in a way to give enough space for the particular plant to grow and another similar plant within that tray and on other trays as well.

Additionally, in accordance with an embodiment of the present invention, the system further comprises a stand placed in a fish tank. In use, the stand enables each tray to bring in proximity of water and to solve the problem of space constraints.

In accordance with an embodiment of the present invention, the invention as disclosed herein is a system designed for growing a variety of plants in an automated carousel-like structure using both aquaponics and soil as a medium. This system is composed of several key components, including, but not limited to, cultivation units, which are the compartments where the plants are housed.

Each unit is positioned in a specific configuration to optimize the growth of the plants. The configuration is purposeful, meaning it is designed with the specific needs of the plants in mind.

In accordance with an embodiment of the present invention, the system further includes a Photonic Emission Device, which is a device made up of numerous Light Emitting Diodes (LEDs). LEDs are a type of electronic light source that are energy efficient and can be precisely controlled. The photonic emission device is designed to distribute light energy to the cultivation units, providing the necessary light for the plants to carry out photosynthesis, the process by which plants convert light energy into chemical energy to fuel their growth.

In accordance with an embodiment of the present invention, the system further includes an Integrated Hydrological Resource and Electrical Power Supply, which are the systems that provide water and electricity to the cultivation units. The hydrological resource is a water supply system that is integrated into the overall system, ensuring that the plants have the necessary water to grow. The electrical power supply provides the energy needed to power the LEDs and any other electrical components of the system.

In accordance with an embodiment of the present invention, the system further includes an Aquaponics Infrastructure as a system that combines conventional aquaculture (raising aquatic animals such as fish in tanks) with hydroponics (cultivating plants in water) in a symbiotic environment. In this system, the waste produced by the aquatic animals serves as a natural fertilizer for the plants, which in turn purify the water, creating a sustainable ecosystem that reduces water consumption to one-sixth of traditional methods.

In use, the embodiments of the present invention are designed to emulate a panoramic Ferris wheel structure, which allows for maximum exposure of the plants to the LED light source. This unique configuration also facilitates automation, allowing for a hands-off operation from the sowing of the seeds to the harvesting of the plants.

In use, this invention also includes a number of specially engineered cultivation units that are attached to the Ferris wheel structure. These units are designed to maintain rotational equilibrium based on the specific species of plants being cultivated. This means that the weight distribution of the plants is taken into account to ensure that the Ferris wheel can rotate smoothly and evenly. In addition, the system incorporates an array of receptacles affixed on the cultivation units. These receptacles provide sufficient space for cohabitation of similar plant species within a single cultivation unit and across multiple units. This allows for a diversity of crop sizes to be grown in the system. Moreover, the system also includes a support stand stationed within an aquaponics tank. This allows each cultivation unit to access nearby water resources and addresses any spatial limitations that might exist.

Additionally, the system operates in a way that the plants are first sown in a terrestrial medium and then transition to automated nurturing until the point of harvest. This means that the initial planting is done in soil, but the ongoing care and growth of the plants is managed by the automated system. Finally, the system is designed to forgo the use of any external chemical fertilizers or additives in the cultivation process. This means that the system relies solely on the natural nutrients provided by the aquaponics system and the soil to support the growth of the plants.

In summary, this invention provides a sustainable and efficient method for growing a variety of plants in an automated carousel-like structure using both aquaponics and soil as a medium. It combines the benefits of LED lighting, automated care, and a symbiotic aquaponics system to create a unique and effective solution for plant cultivation.

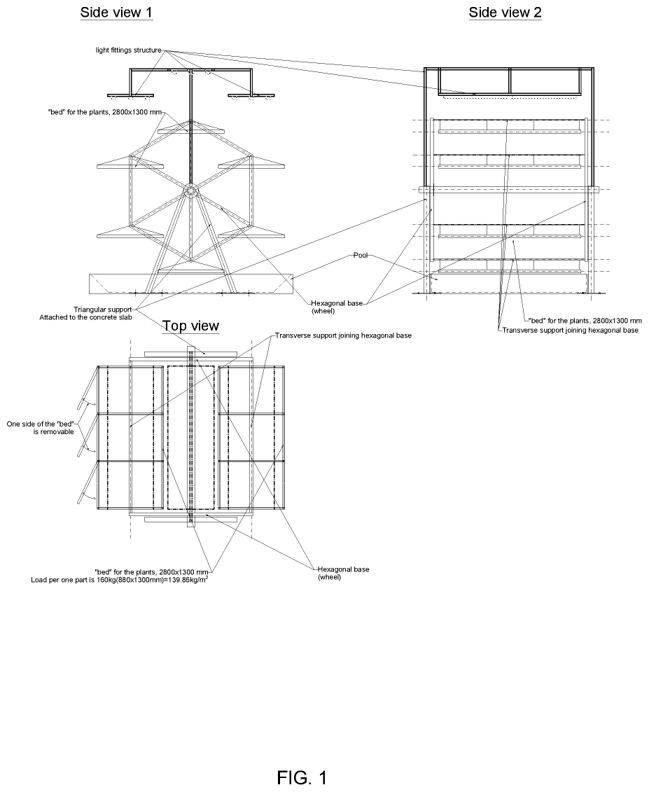

As discussed herein, FIG. 1 illustrates various views of a system for growing a plurality of plants as an automated carousel using aquaponics and soil as a medium. In use, the FIG. 1 illustrates both side views and the top view. In one exemplary embodiment, it has been illustrated that a “bed” for plants include light fitting structures mounted above said “bed” for plants. This system further includes a hexagonal base (wheel) and a triangular support. In use, one side of the bed is removable. Essentially, various features as illustrated therein can be adjusted to achieve the desired configurations.

Therefore, as may be seen, various embodiments of the present invention as disclosed herein above provide significant advantages over the prior art, such as, for example, but not limited to, the present invention uses six times less water compared to usual or traditional aquaponics systems while using the same number of plants. Ability to use different size pots and nurture different sizes of crops, ability to cultivate crops that grow in the soil unlike any other aquaponics systems, significantly reduced number of fish (6 Times) required to provide nutrients as plants are already getting nutrients from the soil and fish water is used to provide even more nutrients for crops, enabling faster harvest time, healthier plants, and regenerating soil. Reducing the number of fish reduces the risk of one of the fish getting sick and affecting others. The aquaponics machine brings the plants to the water, where timing can be defined according to nurtured crops, growth stages and season. The invention doesn't distribute water throughout the growing beds. The design uses fewer components, reduces the risk of mechanical failure, and has more efficient plant growth. The aquaponics machine for indoor farming requires half the LED light capacity compared to any other aquaponics system. Therefore, it reduces capital and running/operating costs, making the farm even more profitable.

Other advantages of the present invention may include, the machine uses less space compared to conventional aquaponics systems. Also, there is no need to keep monitoring levels of nutrients in the water, maintain eco-balance between fish and crops, and there is no need to add any additional additives/nutrients, as plants are getting essential nutrients from organic compost soil and water from the fish tank is acting as additional nutrients provider for crops as well as for soil.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” ‘having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith. Therefore, the appended claims are to be construed to cover all equivalents falling within the true scope and spirit of the invention.

Those of ordinary skills in the art will further appreciate that a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as outlined in the Claims appended herewith. Therefore, the appended claims are to be construed to cover all equivalents falling within the true scope and spirit of the invention.

1. A system for growing a plurality of plants as an automated carousel using aquaponics and soil as a medium, said system comprising:
multiple cultivation units for accommodating the afore-mentioned variety of plants, each unit being positioned in a distinct, purposeful configuration;
a photonic emission device constituted by numerous Light Emitting Diodes (LEDs), designed to distribute light energy to the said cultivation units for photosynthetic activity of the hosted plants;
an integrated hydrological resource and an electrical power supply to facilitate the growth of the afore-mentioned plant variety; and,
a sophisticated aquaponics infrastructure designed to foster plant growth, employing a reduced water requirement and aquatic fauna as the key facilitators, reducing water consumption to one-sixth of traditional methods.

2. The aforementioned system of claim 1, where the unique configuration emulates a panoramic Ferris wheel structure, designed to optimize exposure of the maximum number of plant units to a single LED array from the multiple LED arrays incorporated.

3. The system as stated in claim 1, where the system features automation, facilitating a hands-off operation from sowing to harvesting.

4. The system as delineated in claim 1, where the system employs water abundant with aquatic faunal follicles to supply nutrient requirements of the numerous plant units.

5. The system as stated in claim 2, where each cultivation unit of the multiple units is specially engineered and appended to the Ferris wheel structure, ensuring the unique configuration maintains rotational equilibrium based on the specific flora species cultivated.

6. The system as referred to in claim 1, wherein the system incorporates an array of receptacles affixed on the cultivation units to provide sufficient spatial accommodation for cohabitation of homologous plant species within a singular cultivation unit and across multiple units.

7. The system as mentioned in claim 1, wherein the system includes a support stand stationed within an aquaponics tank to allow each cultivation unit to access proximate water resources and to address spatial limitations.

8. The system as referred to in claim 1, wherein the system incorporates a workflow such that the plurality of plant species are first sown in terrestrial medium and later transition to automated nurturing till the point of harvest.

9. The system as mentioned in claim 1, wherein the system provides the capability to accommodate varying sizes of cultivation receptacles, nurturing a diversity of crop sizes.

10. The system as stated in claim 1, wherein the system is designed such that it forgoes the use of any external chemical fertilizers or additives in the cultivation process.
